(19) United States
(12) Patent Application Publication
(10) Pub. No.: US 2017/0221511 A1
(43) Pub. Date: Aug. 3, 2017

(54) REDUCING CARBONACEOUS SMEAR AT THE NFT AREA ON HAMR HEAD

(71) Applicant: HGST Netherlands B.V., Amsterdam (NL)

(72) Inventors: Qing DAI, San Jose, CA (US); Dongbo LI, San Jose, CA (US); Erhard SCHRECK, San Jose, CA (US); Shaomin XIONG, San Jose, CA (US)

(73) Assignee: HGST Netherlands B.V.

(21) Appl. No.: 15/232,889

(22) Filed: Aug. 10, 2016

(51) Int. Cl. G11B 5/41; G11B 7/126

(52) U.S. Cl. CPC G11B 5/41; G11B 7/126; G11B 2005/0021

(57) ABSTRACT

The present disclosure generally relates a method for removing a smear from a write head in a HAMR system. The smear can be removed by sufficiently heating the smear in an oxidative atmosphere to oxidize the smear. The material buildup that forms the smear has carbon, that when oxidized, is a gaseous product that leaves the write head with a reduced and/or eliminated smear. The heating occurs when the head is disposed in the parking location on the ramp remote from the magnetic media. Heating is possible using the same heat source for the HAMR head that is used to write data to the magnetic media.

### BACKGROUND OF THE DISCLOSURE

Field of the Disclosure

Embodiments of the present disclosure generally relate to a method for cleaning a smear from a write head in a magnetic recording system.

Description of the Related Art

Heat assisted magnetic recording (HAMR) is anticipated to increase the areal density in hard disk drives (HDDs) to multiple terabytes per square inch. During HAMR recording, light from a light source, such as a laser light source, is coupled through a near field transducer (NFT) to heat the magnetic media to the temperature above the Curie point to assist magnetic switching. The intensive heating can cause desorption of organic gas phase contaminants and lubricant molecules on the media surface, and then accumulation and modification of those materials at the NFT area. In particular, the material buildup or smear has been found to be formed around the NFT.

Smear formation is likely triggered by near field optical and/or thermal heating effect. The carbonaceous smear is a common problem in HAMR heads. Smear accumulation during head operation can affect the NFT reliability and also can cause head-disk interface (HDI) issues, such as touch down power change in the drive.

Therefore, there is a need in the art for a method to remove the smear from the write head and in particular, from the NFT area of a HAMR write head.

### SUMMARY OF THE DISCLOSURE

The present disclosure generally relates a method for removing a smear from a write head in a HAMR system. The smear can be removed by sufficiently heating the smear in an oxidative atmosphere to oxidize the smear. The material buildup that forms the smear has carbon, that when oxidized, is a gaseous product that leaves the write head with a reduced and/or eliminated smear. The heating occurs when the head is disposed in the parking location on the ramp remote from the magnetic media. Heating is possible using the same heat source for the HAMR head that is used to write data to the magnetic media.

In one embodiment, a method comprises writing data to a magnetic media using a heat assisted magnetic recording write head, wherein the write head includes a near field transducer, and wherein a light source is coupled to the write head; moving the write head and light source to a parking location; and heating the near field transducer while the write head is at the parking location.

In another embodiment, a method comprises applying a first current to a light source; writing data to a magnetic media using a heat assisted magnetic recording write head, wherein the write head includes a near field transducer, and wherein the light source is coupled to the write head; moving the write head and light source to a parking location; and applying a second current to the light source while the write head is at the parking location, wherein the second current is separate from the first current.

In another embodiment, a method comprises writing data to a magnetic media using a heat assisted magnetic recording write head, wherein the write head includes a near field transducer, wherein a light source is coupled to the write head, and wherein the writing creates a smear on the near field transducer; moving the write head and light source to a parking location; and oxidizing the smear while the write head is at the parking location.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIGS. 1A-1C illustrate a HDD system, according to embodiments described herein.

FIG. 2 is a schematic cross-sectional illustration of a HAMR write head according to one embodiment.

FIG. 3A is a schematic illustration of a write head when viewed from the MFS with a smear on the NFT.

FIG. 3B is a schematic illustration of the write head of FIG. 3A with the smear removed.

FIG. 4 is a flowchart illustrating the method of removing the smear.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates a method for removing a smear from a write head in a HAMR system. The smear can be removed by sufficiently heating the smear in an oxidative atmosphere to oxidize the smear. The material buildup that forms the smear has carbon, that when oxidized, is a gaseous product that leaves the write head with a reduced and/or eliminated smear. The heating occurs when the head is disposed in the parking location on the ramp remote from the magnetic media. Heating is possible using the same heat source for the HAMR head that is used to write data to the magnetic media.

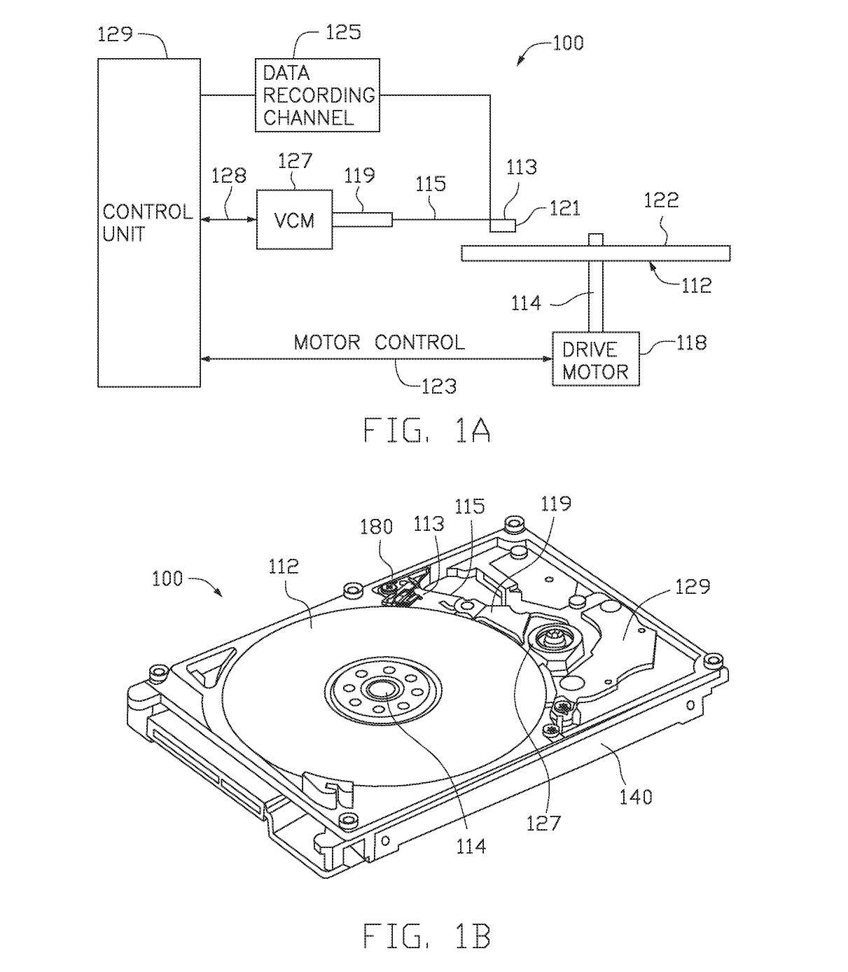

FIGS. 1A-1C illustrate a HDD 100 embodying the disclosure. As shown, the HDD 100 includes a housing 140 having at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one ramp 113 is positioned near the magnetic disk 112, each ramp 113 supporting a slider having one or more magnetic head assemblies 121 that may include a radiation source (e.g., a laser or electrically resistive heater) for heating the disk surface 122. As the magnetic disk rotates, the ramp 113 moves radially in and out over the disk surface 122 so that the magnetic head assembly 121 may access different tracks of the magnetic disk 112 where desired data are written. Each ramp 113 is attached to an actuator arm 119 by way of a suspension 115. The suspension 115 provides a slight spring force which biases the ramp 113 against the disk surface 122. Each actuator arm 119 is attached to an actuator means 127. The actuator means 127 as shown in FIG. 1A may be a voice coil motor (VCM). The VCM comprises a coil movable within a fixed magnetic field, the direction and speed of the coil movements being controlled by the motor current signals supplied by control unit 129.

During operation of a HAMR enabled disk drive 100, the rotation of the magnetic disk 112 generates an air bearing between the slider and the disk surface 122 which exerts an upward force or lift on the slider. The air bearing thus counter-balances the slight spring force of suspension 115 and supports slider off and slightly above the disk 112 surface by a small, substantially constant spacing during normal operation. The radiation source heats up the high-coercivity media to reduce the media coercivity so that the write elements of the magnetic head assemblies 121 may correctly magnetize the data bits in the media. When the head assembly 121 is not in use to either write or read data from the magnetic disk 112, the head assembly 121 is parked in a parking space on the ramp assembly 180.

The various components of the disk drive 100 are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position ramp 113 to the desired data track on disk 112. Write and read signals are communicated to and from write and read heads on the assembly 121 by way of recording channel 125.

The above description of a typical magnetic disk storage system and the accompanying illustration of FIG. 1A-1C are for representation purposes only. It should be apparent that disk storage systems may contain a large number of disks and actuators, and each actuator may support a number of sliders.

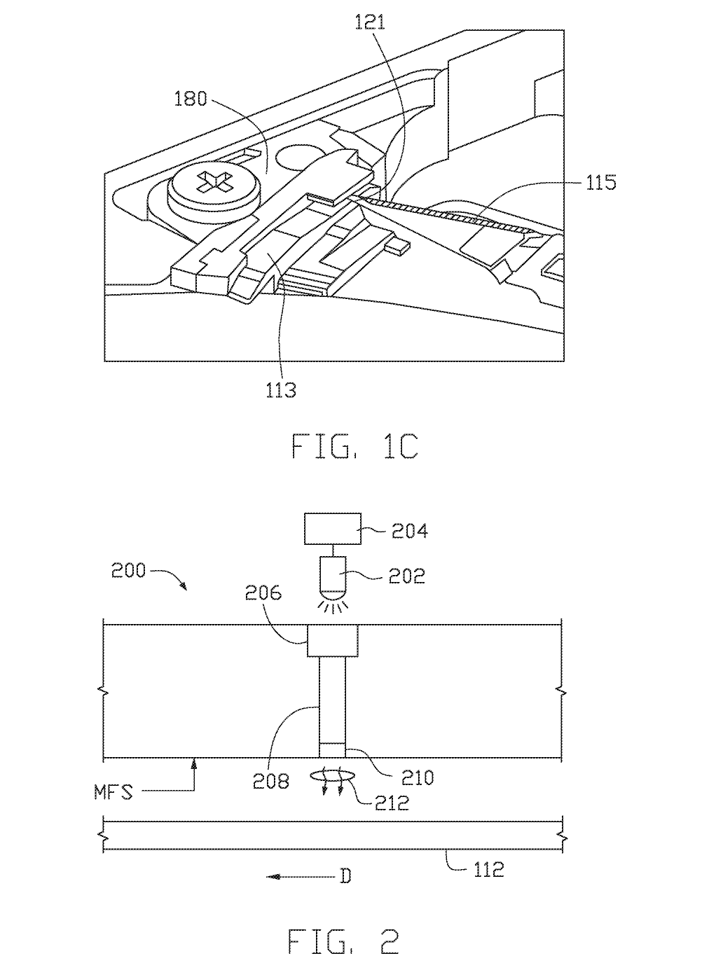

FIG. 2 is a cross sectional schematic of a HAMR enabled write head 200 of the HAMR head assembly 121, according to one embodiment described herein. The head 200 is operatively attached to a light source 202, such as a laser (i.e., a radiation source) that is powered by a light source driver 204, such as a laser driver. The light source 202 may be placed directly on the head 200 or radiation may be delivered from a light source 202 located separate from the slider through an optical fiber or waveguide. Similarly, the light source driver 204 circuitry may be located on the ramp 113 or on a system-on-chip (SOC) associated with the HDD 100 such as the control unit 129 as shown in FIG. 1A. The head 200 includes a spot size converter (SSC) 206 for focusing the radiation transmitted by the light source 202 into the waveguide 208. In some embodiments, the waveguide 208 is part of the SSC 206, meaning the SSC 206 also functions as a waveguide. In another embodiment, the head 200 may include one or more lens for focusing the beamspot of the light source 202 before the emitted radiation reaches the spot-size converter 206. The waveguide 208 is a channel that transmits the radiation through the height of the head 200 to the optical transducer 210—e.g., a plasmonic device—which is located at or near the media facing surface (MFS), such as an air bearing surface (ABS). The optical transducer 210 (i.e., near field transducer or NFT) further focuses the beamspot to avoid heating neighboring tracks of data on the disk 112—i.e., creates a beamspot much smaller than the diffraction limit. As shown by arrows 212, this optical energy emits from the NFT 210 to the surface of the disk 112 below the MFS of the head 200. The embodiments herein, however, are not limited to any particular type of radiation source or technique for transferring the energy emitted from the radiation source to the MFS.

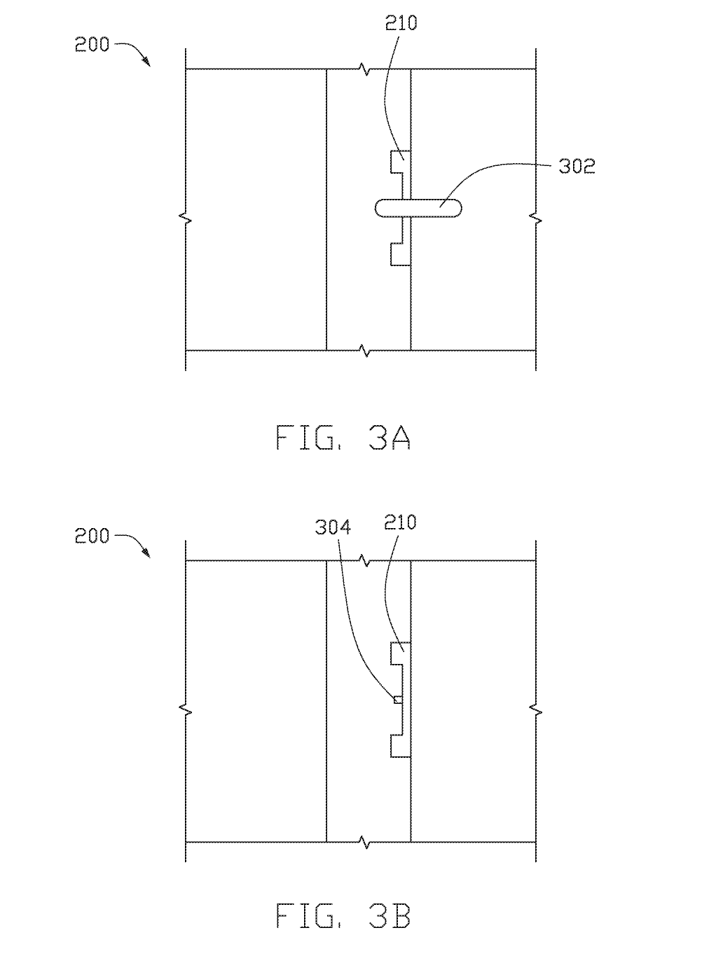

FIG. 3A is a schematic illustration of a write head 200 when viewed from the MFS with a smear 302 on the NFT 210. FIG. 3B is a schematic illustration of the write head 200 of FIG. 3A with the smear 302 removed. The smear 302 forms during write operations on the NFT 210, and more specifically, nearby the notch 304 of the NFT 210 in an “E” shaped NFT. FIG. 3B shows that the smear 302 has been removed. By heating the write head 200, and more specifically, the NFT 210, the smear 302 can be reduced and/or even removed completely.

The method to remove the smear 302 is based on static heating of NFT 210 when the head 200 is positioned at the ramp assembly 180 so that the MFS is exposed to the enclosed HDD 100 environment with no interaction with the media surface. The smear 302 is burned off at high temperatures in presence of oxygen. This has been demonstrated by heating the head with a smear using rapid thermal annealing (RTA). The amount of oxygen that is present can range from the amount of oxygen that is typically present in air to as little amount of oxygen that may be present in helium based drives. In the HDD 100, it is not feasible to apply RTA to remove the smear 302 on the head 200. However, the NFT 210 itself can serve as a good heating source since the transducer temperature can reach as high as 300 degrees Celsius for “E” shaped antennas during recording. When the head 200 is infinitely far away from the disk 112 surface, the temperature of the NFT 210 will be lower due to the absence of plasmonic resonance, however, the temperature can still be sufficiently high to cause nearby smear oxidation and consequently removal. Also, in one embodiment, the recording current for the light source could also be increased to reach higher temperatures.

In order to avoid any materials desorption from the disk 112 upon heating, the head 200 will be positioned at the ramp assembly 180, where the light source 202, such as a laser, is turned on to burn the smear 302 at the NFT 210 area. As shown in FIG. 3B, the smear 302 disappears after turning on the light source 202 on at the currents lower than recording condition for a certain period of time. In one embodiment, the recording current is between about 30 mA and about 100 mA. It is to be understood that the recording current is not to be limited to be between 30 mA and about 100 mA, but rather, may be any recording current consistent with the device proper usage. The smear 302 removal may occur at currents that could heat the NFT area to a couple hundred degrees Celsius. Therefore, the smear 302 removal may occur at a time that is distinct from the recording current. In one embodiment, the removal occurs at currents that are up to about one half of the recording current. In another embodiment, the smear 302 removal occurs at currents that are between about 20 percent and about 300 percent of the recording current, though the removal current is applied separately from the recording current. In other words, two distinct currents are applied, a first current (i.e., the recording current) and a second current (i.e., the smear removal current). In one embodiment, the first current and the second current may be the same, yet applied at distinct, separate times. In another embodiment, the smear removal current is between about 30 mA and about 40 mA. The temperature achieved during the smear removal is between about 100 degrees Celsius and about 300 degrees Celsius. The heating causes the smear to oxidize and produce products that contain carbon based gases such as CO, CO₂ and combinations thereof. The smear removal may take anywhere from a few seconds to a few minutes, such as between about 1 second to about 1 minute. The smear removal may occur in any HDD environment, even helium or nitrogen based HDDs so long as the oxygen content of the atmosphere inside the housing 140 is at least about 1 percent.

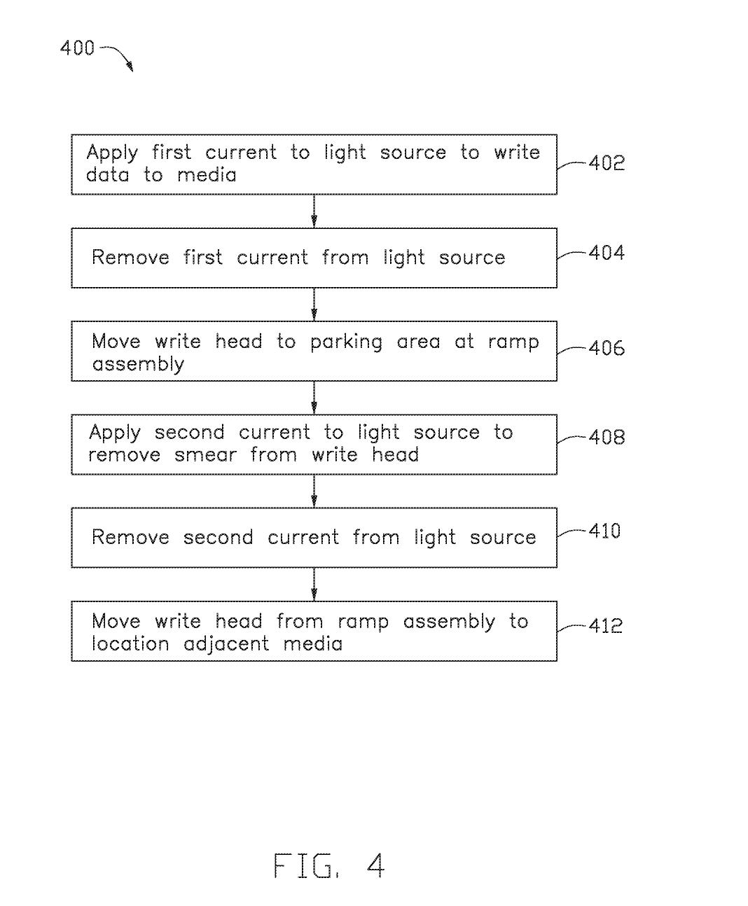

FIG. 4 is a flowchart 400 illustrating the method of removing the smear. The method begins at block 402 by first applying a write current to the light source 202 to write data to the media or disk 112. As discussed above, the write or first current may be, but is not limited to, between about 30 mA and about 100 mA. During the write operation, a smear 302 will undesirably form. Once the write operation is completed, the first current is turned off or removed from the light source at block 404. Multiple write operations may occur prior to moving the write head 200 to the parking area at the ramp assembly 180 in block 406 or the head 200 may be moved to the parking area after each write operation. Once the head 200 is in the ramp assembly 180, a second current is applied to the light source 202 to remove the smear 302 from the write head 200, or more specifically, nearby the notch 304 of the NFT 210 in block 408. In one embodiment, the removal occurs at currents that are up to about one half of the recording current. In another embodiment, the smear 302 removal occurs at currents that are between about 20 percent and about 300 percent of the recording current, though the removal current is applied separately from the recording current. In other words, two distinct currents are applied, a first current (i.e., the recording current) and a second current (i.e., the smear removal current). In one embodiment, the first current and the second current may be the same, yet applied at distinct, separate times. In another embodiment, the smear removal current is between about 30 mA and about 40 mA. Thereafter, the second current is removed from the light source 202 in block 410 and the write head 200 is ready to perform write operations again. Thus, the write head 200 is then moved from the ramp assembly 180 to a location adjacent the media or disk 112 to perform the next write operation in block 412.

By utilizing the light source within a HAMR recording system, any smears that are formed may be easily removed so that the NFT reliability is maintained, HDI issues are avoided, and touch down power changes are avoided.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
writing data to a magnetic media using a heat assisted magnetic recording write head, wherein the write head includes a near field transducer, and wherein a light source is coupled to the write head;
moving the write head and light source to a parking location; and
heating the near field transducer while the write head is at the parking location.

2. The method of claim 1, wherein the heating occurs for between about 1 second to about 1 minute.

3. The method of claim 2, wherein the near field transducer is heated to a temperature of between about 100 degrees Celsius and about 300 degrees Celsius.

4. The method of claim 3, wherein the heating occurs in an environment containing at least about 1 percent oxygen.

5. The method of claim 1, wherein the near field transducer is heated to a temperature of between about 100 degrees Celsius and about 300 degrees Celsius.

6. The method of claim 1, wherein the heating occurs in an environment containing at least about 1 percent oxygen.

7. A method, comprising:
applying a first current to a light source;
writing data to a magnetic media using a heat assisted magnetic recording write head, wherein the write head includes a near field transducer, and wherein the light source is coupled to the write head;
moving the write head and light source to a parking location; and
applying a second current to the light source while the write head is at the parking location, wherein the second current is applied separately from the first current.

8. The method of claim 7, wherein the applying a second current occurs for between about 1 second to about 1 minute.

9. The method of claim 8, wherein the applying a second current occurs in an environment containing at least about 1 percent oxygen.

10. The method of claim 9, wherein the first current is between about 50 mA and about 70 mA.

11. The method of claim 10, wherein the second current is between about 20 percent and about 300 percent of the first current.

12. The method of claim 7, wherein the applying a second current occurs in an environment containing at least about 1 percent oxygen.

13. The method of claim 7, wherein the first current is between about 50 mA and about 70 mA.

14. The method of claim 13, wherein the second current is between about 20 percent and about 300 percent of the first current.

15. The method of claim 7, wherein the second current is between about 20 percent and about 300 percent of the first current.

16. The method of claim 7, wherein the second current is up to about one half of the first current.

17. A method, comprising:
writing data to a magnetic media using a heat assisted magnetic recording write head, wherein the write head includes a near field transducer, wherein a light source is coupled to the write head, and wherein the writing creates a smear on the near field transducer;
moving the write head and light source to a parking location; and
oxidizing the smear while the write head is at the parking location.

18. The method of claim 17, wherein the oxidizing occurs for between about 1 second to about 1 minute.

19. The method of claim 17, wherein the oxidizing occurs in an environment containing at least about 1 percent oxygen.

20. The method of claim 17, wherein the oxidizing produces at least one product selected from the group consisting of CO, CO₂ and combinations thereof.
